(19) United States
(12) Patent Application Publication
(10) Pub. No.: US 2018/0156159 A1
(43) Pub. Date: Jun. 7, 2018

(54) REGENERATIVE HYBRID ROCKET MOTOR

(71) Applicant: Additive Rocket Corporation, Oceanside, CA (US)

(72) Inventor: Kyle Adriany, Oceanside, CA (US)

(21) Appl. No.: 15/644,574

(22) Filed: Jul. 7, 2017

Related U.S. Application Data
(60) Provisional application No. 62/361,305, filed on Jul. 12, 2016.

(51) Int. Cl. F02K 9/72; F23R 3/00; F23R 3/28

(52) U.S. Cl. CPC F02K 9/72; F23R 3/28; F23R 3/002

(57) ABSTRACT

Aspects of the present disclosure are presented for a hybrid rocket engine with regenerative fuel capability having a permeable inner wall structure that allows for non-solid fuel propellant to seep through and be used to generate thrust. The regenerative hybrid rocket motor design of the present disclosures may utilize various non-solid materials found in space, such as asteroid regolith, as fuel that can be provided through the permeable inner wall structure, even in a generally unrefined capacity. The design and placement of the permeable wall structure on the inside of the nozzle portion of the rocket may allow for a calculated layer of non-solid fuel propellant to seep through, due to the pressurized differential properties of space, and be exposed to an oxidizer element, which can then be ignited to generate thrust, thereby allowing for a propulsion system that can be refueled more easily. Other industrial applicabilities are also disclosed.

### CROSS REFERENCE TO RELATED APPLICATION

This application claims the benefit of U.S. Provisional Application 62/361,305, filed Jul. 12, 2016, and titled, “REGENERATIVE HYBRID ROCKET MOTOR,” the disclosure of which is hereby incorporated herein by reference and for all purposes.

### TECHNICAL FIELD

The subject matter disclosed herein generally relates to propulsion systems. More specifically, the present disclosures relate to a regenerative hybrid rocket motor design with various industrial applicabilities.

### BACKGROUND

Liquid bipropellant engines rely on highly refined and purified fuels and oxidizers which are injected into the chamber as a spray before combusting. Solid rocket motors ignite a solid fuel grain, lining the interior wall of the engine, to produce a constantly changing amount of thrust until the solid fuel has been consumed. Hybrid engines utilize a solid fuel grain, lining the inner wall, along with an injected oxidizer (or vice versa). It would be useful to develop engines that can utilize less refined fuels when refining capability is scarce.

### SUMMARY

Aspects of the present disclosure are presented for an engine with regenerative fuel capability having a permeable inner wall structure that allows for non-solid fuel propellant to seep through and be used to generate thrust.

In some embodiments, the engine may include: a non-permeable outer wall casing; a permeable inner wall; an intra-wall propellant channel between the non-permeable outer wall and the permeable inner wall; and a combustion chamber formed at least in part by the permeable inner wall. The intra-wall propellant channel may be configured to permit a non-solid propellant to flow between the non-permeable outer wall and the permeable inner wall. The permeable inner wall may be configured to permit the non-solid propellant to porously flow through the permeable inner wall, from the intra-wall propellant channel to the combustion chamber.

In some embodiments, the engine further includes an igniter positioned at a forward portion of the combustion chamber. In some embodiments, the igniter is configured to inject an oxidizer element into the combustion chamber. In some embodiments, thrust is generated when the oxidizer element ignites with the non-solid propellant that flows into the combustion chamber through the permeable inner wall. In some embodiments, mass flow of the oxidizer element is modulated to generate a desired thrust profile.

In some embodiments of the engine, the non-solid propellant is drawn into the combustion chamber through the permeable inner wall by a pressure differential between the combustion chamber and the intra-wall propellant channel. In some embodiments, the pressure differential is formed at least in part by the vacuum of space.

In some embodiments, the engine further includes a solid fuel grain positioned within the combustion chamber. In some embodiments, the non-solid propellant is configured to protectively coat the combustion chamber through the permeable inner wall as the solid fuel grain is burned to create thrust.

In some embodiments of the engine, the permeable inner wall comprises a plurality of porous passages configured to permit non-solid flow from one side of the permeable inner wall to an opposite side. In some embodiments, the plurality of porous passages vary in size. In some embodiments, the sizes of the porous passages are determined based on a desired thrust profile calibrated to varying amounts of non-solid propellant that are permitted to flow through the permeable inner wall due to the varying sizes of the porous passages.

In some embodiments of the engine, the inner permeable wall is shaped to a specified geometry such that combustion of fuel in the combustion chamber generates a desired thrust profile.

In some embodiments of the engine, the inner permeable wall includes porous passages of specified sizes such that combustion of fuel in the combustion chamber generates a desired thrust profile.

In some embodiments, the engine further includes a refueling chamber coupled to the intra-wall propellant channel and configured to permit refueling of the non-solid propellant.

In some embodiments of the engine, the non-permeable wall structure and the permeable inner wall structure are generated using additive manufacturing techniques.

In some embodiments, the engine further includes a nozzle coupled to an aft portion of the combustion chamber.

In some embodiments, the engine further includes one or more pistons driven by combustion of fuel in the combustion chamber.

In some embodiments, the engine further includes one or more turbine propellers.

### BRIEF DESCRIPTION OF THE DRAWINGS

Some embodiments are illustrated by way of example and not limitation in the figures of the accompanying drawings.

FIGS. 1A, 1B, and 1C provide generic schematics of a typical hybrid rocket engine for background purposes.

FIG. 2 shows a cross-sectional view of a thrust chamber portion and surrounding structures of a regenerative hybrid rocket motor, according to some embodiments.

FIG. 3 shows a set of example thrust profiles generated by corresponding thrust chamber geometries shown herein.

FIG. 4 shows several examples of porous surfaces that may be used in the permeable wall structures described herein, according to some embodiments.

### DETAILED DESCRIPTION

Currently, there is not a method for refueling solid or hybrid engines in space, during an extended mission. Although it is possible to refuel liquid engines in space, using chemicals found on asteroids, the amount of purification necessary for a clean burn is prohibitive.

Aspects of the present disclosure are presented for a hybrid rocket engine with regenerative fuel capability having a permeable inner wall structure that allows for non-solid fuel propellant to seep through and be used to generate thrust. In some embodiments, the regenerative hybrid rocket motor design of the present disclosures may utilize various non-solid materials found in space, such as asteroid regolith, as fuel that can be provided through the permeable inner wall structure, even in a generally unrefined capacity. As will be described in more detail below, the design and placement of the permeable wall structure on the inside of the thrust chamber portion of the rocket may allow for a calculated layer of non-solid fuel propellant to seep through, due to the vacuum properties of space, and be exposed to an oxidizer element, which can then be ignited to generate thrust. In this way, embodiments of the present disclosure may allow for a propulsion system that can be refueled more easily while in space, utilizing readily available resources when conducting space exploration or even asteroid mining.

In some embodiments, regardless of the purity or impurity of the fuel or oxidizer used, no impurities will be able to build up on the interior of the chamber to alter performance. The propellant seeps from an internal passage within the engine wall into the chamber, through a permeable inner wall, from the outside in. This allows minimally refined propellants to be used. Furthermore, the presence of the fuel coating along the interior of the wall prevents excessive heat from transferring from the combustion reaction into the structural components of the engine.

The design of the present disclosures allows for a feed system which does not require a pump. Instead, the difference in pressure between the propellant tank and the vacuum of space is sufficient to slowly draw propellant from the tank, through the porous inner wall to line the interior of the chamber. A single valve can be opened or closed to allow or prevent the flow of fuel. The valve can remain open until a sufficient amount of propellant has lined the chamber wall. After a sufficient amount of fuel has been consumed, the flow oxidizing agent, which stimulates the reaction, can be stopped, and the fuel valve can be opened to re-coat the inner wall with a sufficient amount of fuel.

In some embodiments, the porosity of the inner wall can be varied along the axis of the engine (distance from oxidizer inlet) to refuel and regenerate the regions of fuel coating which are consumed at a higher rate. It can also be varied based on the amount of oxidizer present at that location. A more permeable inner wall would be utilized where fuel is consumed at a higher rate. A less permeable inner wall would be used to lightly coat regions of the chamber which do not experience a high rate of fuel consumption.

In some embodiments, other types of engines and other types of industrial applications employing the use of the permeable wall structure are presented.

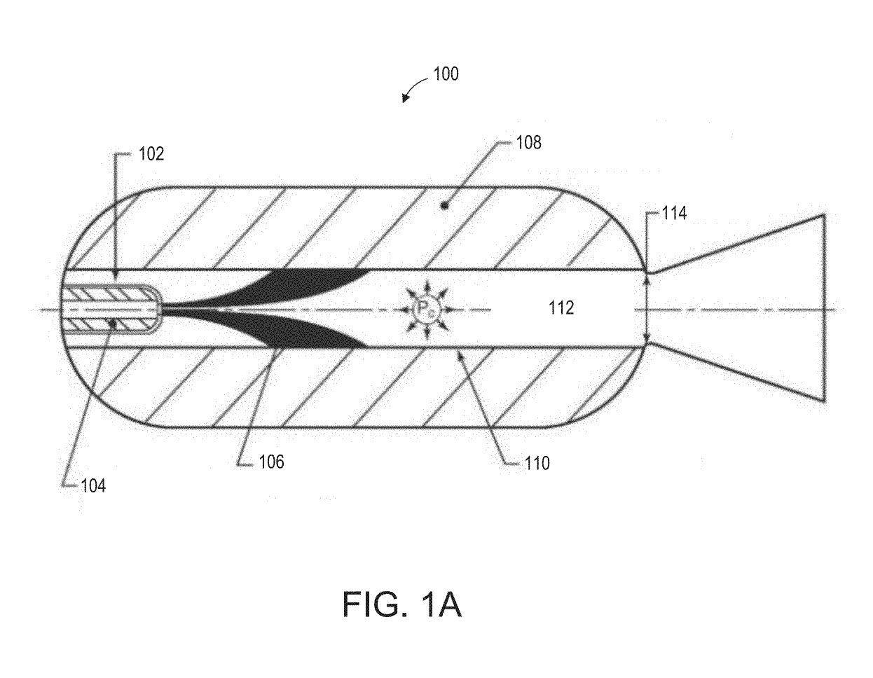

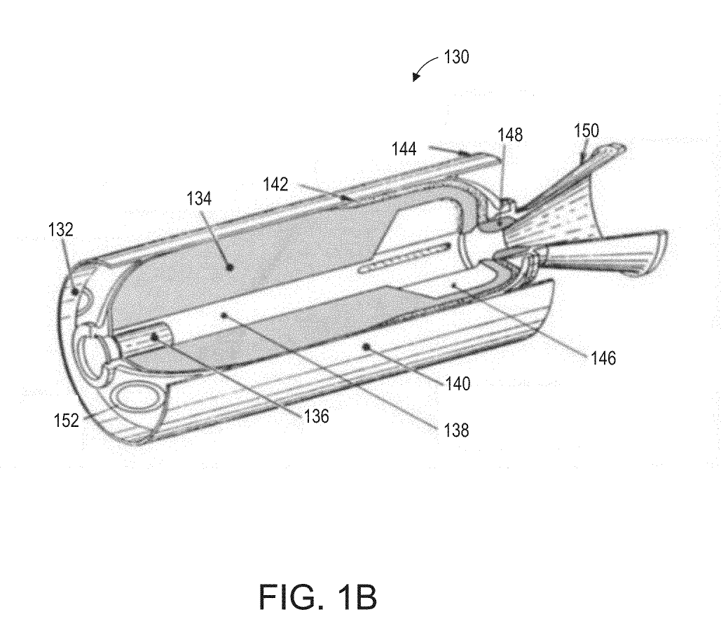

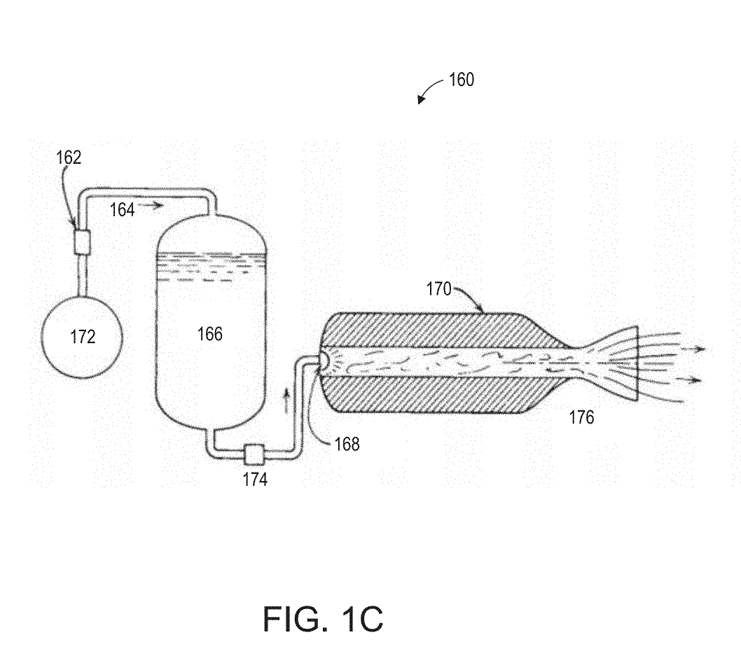

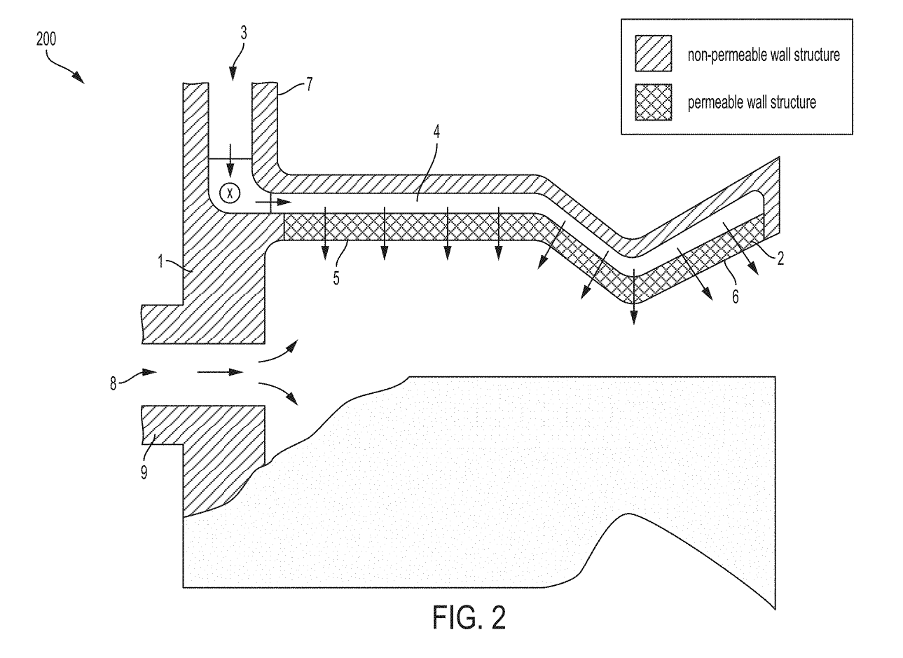

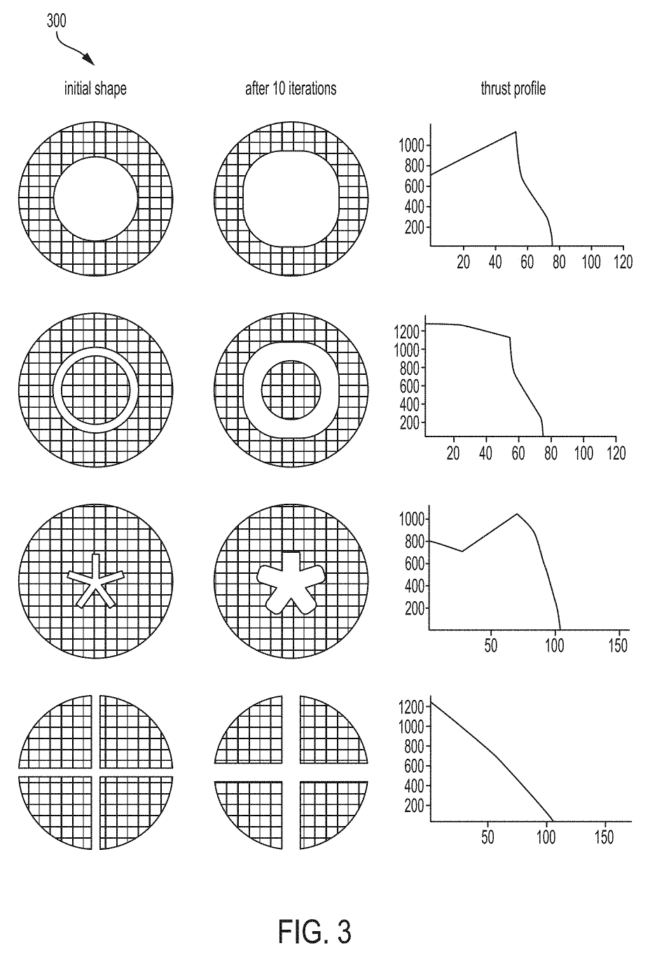

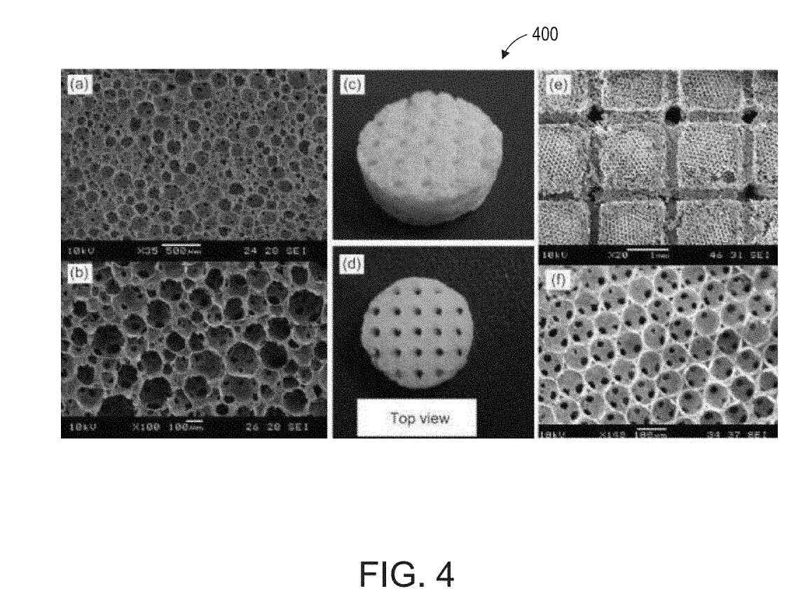

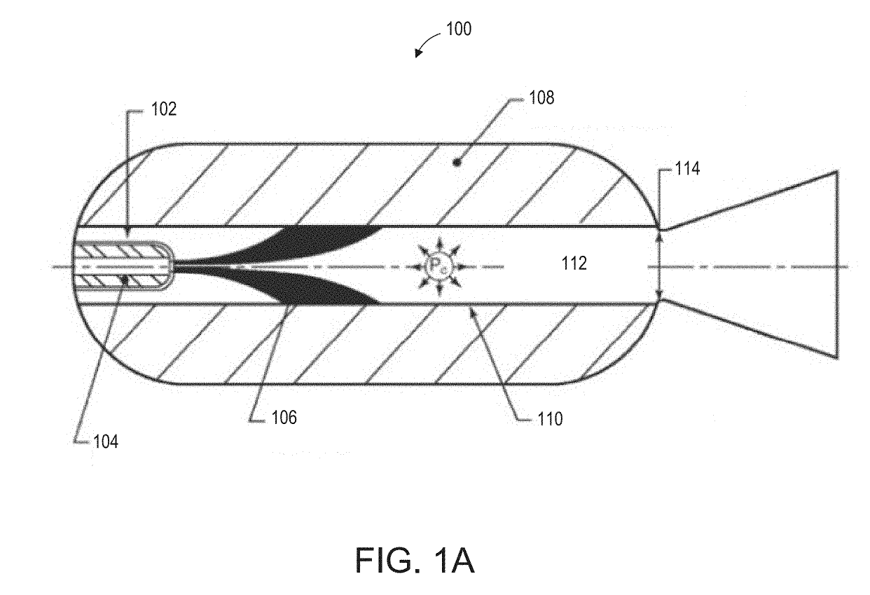

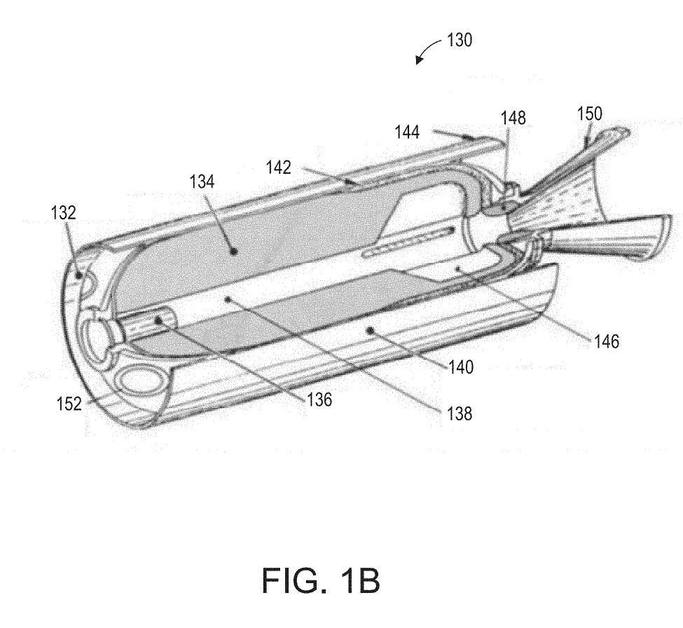

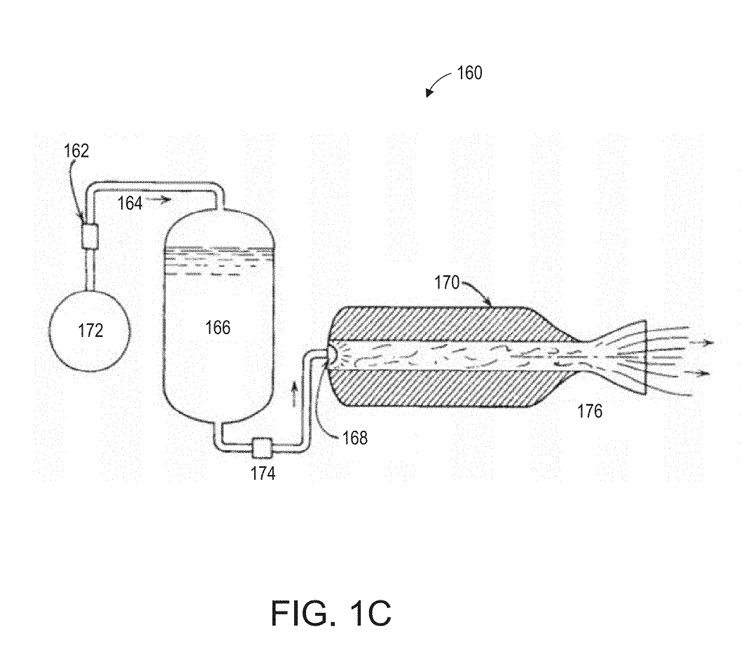

Referring to FIGS. 1A, 1B, and 1C, illustrations 100, 130, and 160, respectively, provide generic schematics of a typical hybrid rocket engine for background purposes. A hybrid engine includes typically a solid fuel component and a liquid oxidizer component, that are combined to generate thrust when ignited by an igniter propellant. The solid fuel component of a hybrid engine is generally quite energy dense, but generally refueling involves replacing solid fuel tanks rather than refilling the same chamber. The fuel grain may be encased in the thrust chamber with a particular geometry to generate an intended thrust profile as it is burned. The solid fuel, such as hydroxyl terminated polybutadiene (HTPB), tends to be highly refined and processed before being supplied to fuel a rocket engine.

In illustration 100, shown are typical components of a rocket engine. Igniter 102 provides igniter propellant 104 that is injected into the chamber according to a certain igniter plume orientation 106. This can vary, depending on the type of thrust profile desired. The igniter propellant 104 then touches the motor propellant fuel 108 (hashed area on both sides of the chamber) that is arranged with a particular motor grain geometry 110 to generate a particular thrust profile. In this case, the motor propellant 108 is positioned around the edge of the cylindrical chamber, with just a cross section shown. The center 112 is hollowed out to allow for a clear path to exit the chamber through the throat area 114.

Referring to FIG. 1B, illustration 130 shows another example of a hybrid engine, this time having a different grain geometry. The engine includes a forward skirt 132 to help attach the engine to a payload and the motor case body 140. The igniter 136 is placed in a similar position as in FIG. 1A. The propellant grain 134 is again positioned radially around the edge of the chamber, leaving a cylinder opening 138. The igniter fluid would be injected into the chamber via the igniter 136 to ignite the fuel grain 134. This time, the back end of the grain has a cylindrical slot 146 to create a particular thrust profile. The engine also includes an aft skirt 144 to improve aerodynamics. The nozzle exit cone 150 is connected at the nozzle throat insert 148, and the thrust exits the chamber through the exit cone 150. Also shown in this example is a thrust termination opening device 152.

Referring to FIG. 1C, in illustration 160, shown is a diagram of the various components used for creating thrust in a hybrid engine. Pressurizing gas 172 can be used to apply pressure to liquid oxidizer 166 via a regulator 162 and through the passage 164 to control the flow of the pressurizing gas 172. A valve 174 can be used to release the liquid oxidizer 166 into the chamber via the oxidizer injector 168. Then, the solid fuel 170 can be ignited in similar manners to what is described in FIGS. 1A and 1B. The resulting thrust exits through the nozzle 176.

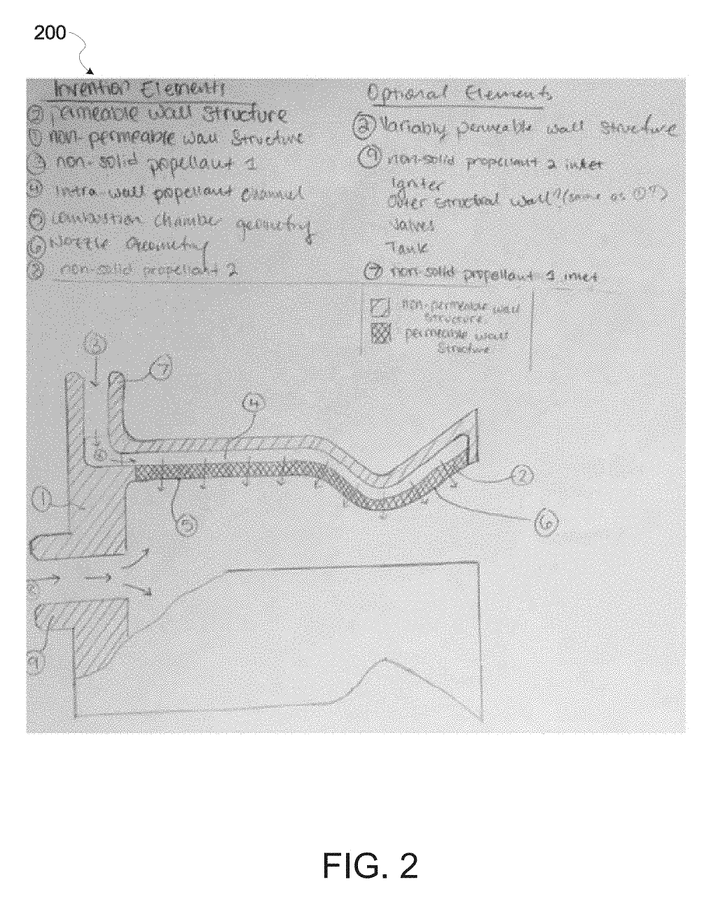

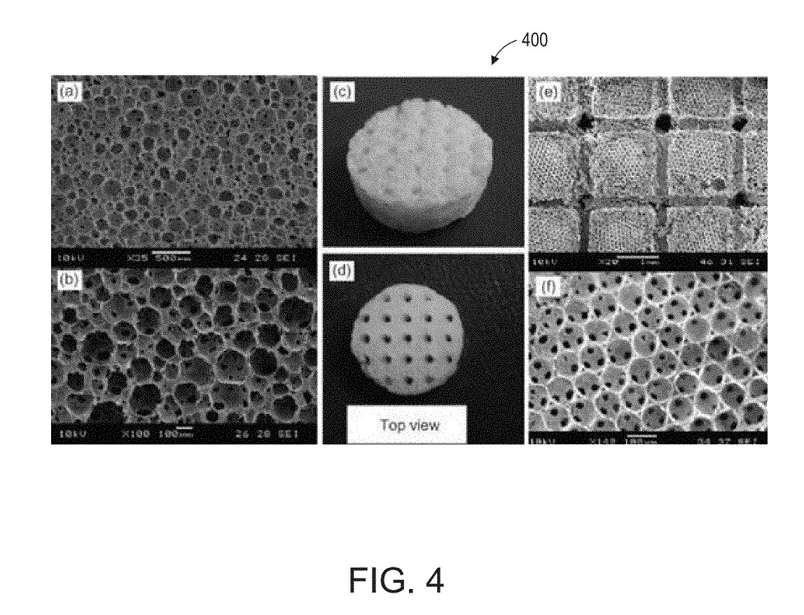

Referring to FIG. 2, illustration 200 shows a cross-sectional view of a thrust chamber of a regenerative hybrid rocket motor, according to some embodiments. The numbered elements in the cross-sectional view correspond to the brief descriptions above it. In particular, illustration 200 shows a permeable wall structure 2 that is also defined by the hash-marked fill-in. See FIG. 4 for examples of additive-manufactured structures that may be used to form this permeable wall. This permeable wall structure is positioned on the inside of the chamber portion of the rocket. Between this permeable wall structure and the outer, solid wall layer (e.g., non-permeable wall structure 1 and similarly diagonally marked structures) exists an intra-wall propellant channel 4. Non-solid fuel propellant 3 may be injected through the non-solid propellant inlet 7 and may flow along the intra-wall propellant channel 4. Based on the pressurized properties inside the channel, the non-solid propellant 3 may first fill the intra-wall propellant channel before seeping through the permeable wall structure, according to some embodiments. Over time, the non-solid fuel propellant 3 may seep through the permeable wall structure and coat the opposite side of the wall structure, due to natural pressurized forces, such as the vacuum of space. That is, the vacuum existing on the open portion of the chamber and the opposite side of the permeable wall structure 2 may act as a pulling force to draw the non-solid fuel propellant out from the intra-wall propellant channel 4 and through the porous permeable wall structure 2. The fuel inlet 7 may be closed off after enough non-solid fuel has filled the channel. Eventually, a layer of the non-solid fuel propellant will form on the opposite side of the permeable wall structure 2. While the permeable wall structure 2 allows for the non-solid fuel to form on the opposite side of the wall, the time it takes to seep through to the other side is typically substantially longer than it would take for the non-solid fuel to fill the intra-wall propellant channel 4. Thus, the entire intra-wall propellant channel 4 can be filled with the non-solid fuel—as if to be loaded up in preparation for a longer fuel burn-before the non-solid fuel would completely seep through the permeable wall 2.

Still referring to FIG. 2, the non-solid propellant inlet 9 may allow for a liquid oxidizer agent, such as nitrous oxide, to be injected out into the nozzle with a spray directed at the non-solid fuel propellant 3 coated along the permeable wall structure 2. Not shown are other more common portions of a rocket engine, including an igniter, valves, and one or more tanks to house the fuel and oxidizer materials. Using known methods for igniting fuel propellant with liquid oxidizer propellant, thrust may be generated by the ignition of the non-solid fuel propellant coated along the permeable wall structure when in contact with the oxidizer propellant.

When more thrust is desired, the inlet 7 may be reopened and more non-solid fuel propellant may fill the intra-wall propellant channel 4. The same natural pressurized process to draw the non-solid fuel propellant through the porous wall structure of the permeable wall structure 2 will again occur, and the fuel may again be ignited. The amount of fuel burned through each ignition process will be generally limited by the amount of liquid oxidizer injected onto the non-solid fuel propellant layer. Once the amount of liquid oxidizer touching the non-solid fuel propellant layer is burned off, generally the rest of the non-solid fuel will not continue to burn. In addition, while the non-solid fuel that is burned rests next to or very close to the permeable wall structure 2, in some embodiments, the spraying of the liquid oxidizer onto the non-solid fuel may be designed to be evenly distributed such that a portion of the layer of the non-solid fuel continually persists to act as a coating over the vacuum-side of the permeable wall structure 2. In this way, no melting or damage to the permeable wall structure will occur.

In some embodiments, while illustration 200 shows a cross-section of the nozzle portion of the rocket, most of what is shown may exist uniformly around the cylindrical contours of the nozzle portion of the rocket engine. That is, for example, the permeable wall structure 2 may exist uniformly around the cylindrical contours of the inside portion of the chamber, and the intra-wall propellant channel 4 may exist between that and the outer wall of the nozzle, effectively forming a cylinder of space between the inner and outer walls. In some embodiments, the non-solid fuel propellant inlet 7 may reach the intra-wall propellant channel 4 only at finite points, rather than have a uniform circular inlet all the way around.

In some embodiments, the permeable wall structure may allow for the passage of non-solid fuel to occur through a number of different characteristics that simulate the desired porous nature. For example, this transmission can occur through several various mechanisms: small channels connecting the fluid jacket to the combustion chamber, non-specific/non-directional porosity, or directional porous membrane. In some embodiments, the small or micro channels may be uniformly designed and distributed throughout the permeable wall structure, while in other cases a random walk of porous elements may be present.

Regarding the size of the fluid/fuel channels (taking the form of tubes, rectangular passages, or slots) in the permeable wall structure, these passages may be anywhere from 20 mm in hydraulic diameter (the effective diameter of a non-circular flow passage) to 3 micrometers, according to some embodiments.

Alternatively, in some embodiments, non-channel-like passages, which are defined as regions absent of material which permit the transmission of a fluid along an arbitrary flow path from the fuel source to the chamber, allow for the creation of the engine. Typically, the hydraulic diameter of such flow paths is on the order of ˜0.01-100 mm. Porous indirect passages can enhance flow through capillary action. Fluid passages, which take the form of porous structures, can enhance the uniformity of the desired fuel distribution and flow rate by providing multiple paths to the location of fuel deposition within the chamber.

For different embodiments, the size, distribution, and type of fuel transmission mechanism can be varied both axially and azimuthally to achieve the desired thrust, performance, longevity, and/or manufacturability of the engine. Using additive manufacturing techniques, the porosity may be varied at each location along the wall. This can change the fuel mass flow at every point along the wall as desired. The relative size of the hydraulic diameter of a fluid passage determines the amount of fuel that will be delivered to the chamber. Passages which are larger, relative to others fed from the same fuel source, will transmit a greater amount of fuel into the chamber. As a result of these variances, the thrust profile can be shaped to simulate thrust profiles based on solid fuel grain. The total amount of fuel fed into the engine is determined, in part, by the duration of firing (fire-time) and the amount of thrust required.

For different embodiments, the geometry of the permeable wall structure 2 can be varied to achieve a desired thrust profile, in addition to (or alternatively) changing the porosity. In the example of FIG. 2, the combustion chamber geometry 5 relating to the permeable wall structure 2 is wider, long and straight. Down the aft portion of the chamber, however, the nozzle geometry 6 of the permeable wall structure shows a bend inward, and then a bend outward to form the nozzle portion. These geometries generate a particular thrust profile that may be dictated by mission parameters or other performance specifications of the engine.

Axial variation in fuel transmission, created by axial variations in the size, distribution, and type of constituent passages, allow for the axial distribution of fuel throughout the chamber in accordance with the expected fuel regression rate. Similarly, azimuthal variation in pore size and fuel transmission enables the creation of fuel grain shapes, similar to those of traditional solid motors. Regression, or the amount of fuel consumed over a given amount of time at a given location along the inside of the chamber, is related to the initial shape of the combustion chamber, the initial shape and distribution of fuel throughout the chamber, the flow of fuel that is injected during the firing of the engine, and the chemical nature of the fuel(s) and oxidizer(s) used. The regenerative hybrid engine described here can produce a particular distribution of fuel in the chamber. Such a distribution can be optimized for the desired thrust versus fire-time.

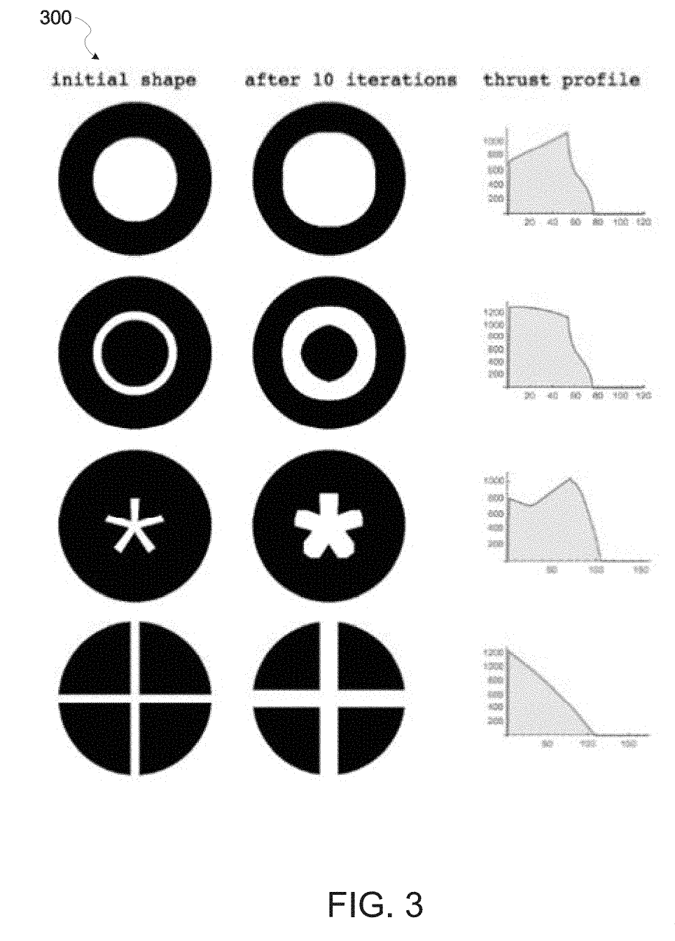

Referring to FIG. 3, illustration 300 shows a set of example thrust profiles generated by corresponding fuel grain geometries shown herein. It may be desirable to employ different thrust profiles in order to account for different mission parameters, such as burn duration, desired impulse, g-force sensitivity of onboard electronics or life-forms, or timing issues that demand different thrust at different times. The white spaces in each of the example fuel grain geometries represents the area available in the fuel grain chamber, and may define the volume of the fuel grain chamber when assuming a uniform depth of the same fuel grain geometry. Example thrust profiles are shown to the right of these geometries, illustrating an amount of thrust generated over time and assuming other properties about the rocket engine are equal. While these geometries may not be realistic to equip to a rocket engine in real life, the porosity of the permeable wall structure may be varied to mimic or simulate these same thrust profiles. This can be achieved even when the permeable wall structure is positioned only on the inside portion of the combustion chamber and does not need to be positioned in any nonstandard way, such as along the walls of these shown in illustration 300. In this way, aspects of the present disclosure may allow for varying thrust profiles that typically are not achievable with conventional hybrid engines.

An azimuthal variation in fuel transmission enabled by azimuthal variation in size, distribution, and type can likewise alter the thrust over time produced by the engine throughout the duration of the firing. Statistical distributions of azimuthally varying pore size may be chosen or optimized to achieve the desired thrust curve as depicted in the figure of traditional hybrid fuel grain shapes and their resulting thrust curves.

Referring to FIG. 4, illustration 400 shows several examples of porous surfaces that may be used in the permeable wall structures described herein, according to some embodiments. These examples may be reproduced using additive manufacturing techniques. It can be seen that some cases utilize a more uniform lattice structure, while others utilize a more random porous surface. Methods for generating varying types of porous surfaces are known to those with skill in the art, and these techniques may be used to create the permeable wall according to some aspects of the present disclosure.

Permeable Wall to Provide Protective Layer

Additionally, specific axial distributions of fuel can be used to prevent damage to the combustion chamber and/or nozzle via burning, melting, corrosion, intermittent instabilities and/or thermal stress caused by repetitive heating and cooling of the engine. Coating the nozzle in a small amount of fuel prevents the high temperature corrosive gases from interacting with the transmissive wall structure, and thus preventing damage. In other words, the fuel coating the walls of the chamber can act as a thermo-chemical barrier, as a protective layer, and as a method of cooling a chamber. The permeable wall structure as part of an engine can be used with any liquid and viscous semisolids to achieve these effects Similarly, fuel that is not consumed during the combustion/reaction process can be transmitted to axial locations along the engine, either during the firing, or before, to prevent the products from interacting with the transmissive wall structure and/or to cool the inner chamber wall in the event of interaction with hot gasses. This increases engine longevity.

Similar to the utilization of intra-wall propellant as a means of protection from wall melting and wall cooling while being used primarily as a means of propellant injections, in an alternative engine configuration, such as the liquid bipropellant or mono-propellant thruster types, a similar porous or channeled wall structure may be used in conjunction with canonical injector schemes to enhance cooling and create a thermal and chemical barrier between the high temperature corrosive chemicals within the chamber and the wall. This barrier substance may be liquid or semi-solid, and may be a fuel, oxidizer, or other added substance. In this embodiment, the pores or channels used are significantly smaller as they must account for less of the total fluid mass flow. Furthermore, fluid flow through the permeable wall would likely be driven by the pressure source responsible for the primary propellant flows. Thus, in some embodiments, the vacuum of space may drive the fluid flow through the permeable wall, while in other cases of an engine in atmospheric conditions with gravity, external pressures or a design utilizing the effects of gravity can help to drive the fluid flow.

Methods for Implementation and Manufacturing

Available additive manufacturing methods are capable of controlling the porosity within components. Related production of microchannels, porous membranes, or meshes are also manufacturable by means of additive manufacturing. In particular, laser deposition manufacturing, a process in which various metal powders flow through one or more nozzles into a laser path to ultimately fall within a melt pool heated by said laser and become fused to the substrate material containing the melt pool, is capable of controlling material porosity with complete three-dimensional resolution. This is achieved through a careful tuning of laser power in conjunction with metal powder flow rates. Such a manufacturing methodology would ideally be employed to produce the inner wall structure of the regenerative hybrid, since it may require the three-dimensional variation of porosity. Further capabilities of laser deposition include the accurate production of internal directional channels which enable the flow of fluid across the inner wall structure. Manufacturing methods using 3-D printing lend themselves to more easily generating the porous characteristics of the permeable wall structure. In some embodiments, methods for manufacturing the various components of these regenerative hybrid rocket designs are also contemplated within this disclosure.

Binder jetting is one additive manufacturing method which can be used to make metal parts with various degrees for porosity. It utilizes resins to bind metal powder and additives which can be baked away as the metal is sintered in a post processing high temp oven.

An analogous approach, utilizes various amounts of the desired metal suspended in PLA plastic which is printed using fused deposition modeling, similar to most desktop 3d printers.

A preferred manufacturing method for these parts is Laser Deposition. LD shoots jets of various materials into a laser path, creating a sintering melt pool which results in the layer by layer production of a metal part. Recent work from Mazumder at Sandia National Lab has shown the high degree of control over material composition and porosity that is achievable though this method.

Advances software like Autodesk Within is capable of defining a permeable lattice structure with specific porosity and a geometric requirements. For micro-scale channels and larger, traditional CAD tools can be used to create discrete or networked fuel dispersion channels which feed the pores within the thruster.

To manufacture a porous wall structure which has a porosity smaller than the minimum feature resolution of the AM device used, an alternative method may be used. In particular, laser deposition additive manufacturing is capable of producing components of varying density and porosity. To implement spatially varying porosity into a component to be additively manufactured through laser deposition, it is not possible to simply model the porosity or add callouts to the CAD model. This is due to the fact that the features being produced through this method are many times smaller than the minimum feature resolution of the device. Instead, all component features, whether solid or porous, must be modeled as a fully solid material. Metaparameters which govern the laser deposition machine's material flow rate and laser power must be manipulated to generate the desired porosity. For most systems this is accomplished by analyzing the runtime CAM or G-Code path of the laser deposition head, and manually tagging time windows or specific locations within which a change in porosity is desired. Next, using the known relationship between metaparameter and material porosity and density, each region created is assigned a metaparameter. For regions where a slowly changing level of porosity is desired in one or more directions, this is done by generating a 2D or 3D contour plot of metaparameter values, and assigning it to a component region based on laser deposition head location or runtime.

Various metals, or other materials which are capable of withstanding potentially high temperatures along with chemical exposure to potentially corrosive fuels, oxidizers and their additives, may be used to produce the various components of this disclosure.

Regarding systems integration, the engine could be connected to a pressurized system that can be opened and closed with a valve. If the application is for space, then the pressure provided would only need to be sufficient to push the viscous fuel through the porous wall, which could be on the order of one to ten pounds per square inch. The fuel chamber would be located in between the pressure system and the engine. The engine would also be attached to an oxidizer tank, which may be actuated via valve and supplied with sufficient feed pressure via pump, pressure head, or oxidizer self-pressurization.

As previously mentioned, aspects of the present disclosure allow for easier access to refueling of a rocket engine. Refueling the engine can be performed for any duration and at any time, even during firing. The quantity of fuel to enter the chamber can be determined by the pressure and length of refuel allowing specific variability to match each length of fire. Increased buildup of fuel along the inner wall may reduce the efficacy of the grain structure. Additionally, constant refueling, during firing allows the fuel to act as film or transpiration cooling to prevent the hot gas from interacting with the chamber wall.

In addition, refinement of certain fuels used in this design may be reduced or even eliminated. For example, asteroid regolith may be supplied to the fuel tank in its natural form, in some cases. In some embodiments, before supplying the asteroid regolith to the intra-propellant chamber, a coarse filter may be installed to catch any larger particles that may not be small enough to seep through the channels of the permeable wall structure. The remaining particles may flow into the intra-propellant chamber and used directly as fuel.

Regarding burn use time and maintenance, the device may be constructed through additive manufacturing or some other method allowing for the controlled movement of propellant across the inner wall. The engine is designed to be used with viscous fuels which could be mined from asteroid soil. After some chemical processing, the fuel, which is stored in a pressurized tank, will be permitted to flow into the engine by means of an actuated valve. Fuel flows from the tank to the combustion chamber by means of a pressure differential between the pressurized tank and the vacuum of space. Alternatively, the assistance of an arbitrary pumping mechanism may be employed to transport the fuel. When the fuel is allowed to flow, it travels from the tank, to the passages between the inner and outer walls of the chamber, moving through the permeable inner wall. The viscous propellant coats the inner wall of the chamber. Once a predetermined amount of fuel has lined the interior of the combustion chamber, the valve is closed, stopping the flow of fuel. Using a hypergolic (spontaneous) chemical reaction between the injected oxidizing fluid, the fuel ignites. Alternatively, it can use an igniting mechanism capable of producing the temperature/pressure required to stimulate combustion. The combusting fuel undergoes a series of chemical reactions resulting in chemical products with increased volume. The products then exit through the nozzle due to a high pressure differential between the chamber and ambient pressure. The directed ejection of combustion reaction products produce thrust.

Additional Example Applications

Additional use cases are contemplated with this design, according to some embodiments. For example, the porosity of the permeable wall structure may be varied to handle even liquid fuels, or at least less viscous fuels. In addition, the permeable wall structure may be used to conduct transpirational cooling of other types of engines, such as internal combustion engines. In this case, instead of non-solid fuel propellant seeping through the permeable wall structure, nonviscous coolant may fill the intra-wall chamber and be used to cool the combustion chamber from the outside in. In addition, the pressurized nature of the material in the intra-wall chamber seeping through the permeable wall structure may still be achievable even in the presence of an atmosphere and in gravity (e.g., on Earth and not in space), by employing pressure differentials to similarly draw any of the material out through the permeable wall structure. Using known pressure differential techniques, the non-solid fuel propellant for nonviscous coolant can still be drawn into the combustion chamber and counteract the presence of gravity, because the pressure differential required to push the viscous fluid through the permeable structure can be designed to be much greater than the effect of gravity. The effect may be similar to how plants and trees draw liquid up through the capillary root system, thereby counteracting the force of gravity.

In some embodiments, regarding the permeable wall structure seen in the regenerative hybrid, permeable walls may be implemented into the walls of internal combustion engine cylinders to achieve several key benefits. Along with enhancing cylinder longevity, by acting as a thermal barrier and preventing the buildup of combustion residue, such a cylinder would exhibit increased lubrication and reduce wear on the piston components. Since this approach utilizes a thermal barrier as opposed to alternative cooled cylinder designs, more of the thermal energy produced during the combustion process remains within the cylinder throughout that stroke. While it is possible to use permeable walls as the primary method for injecting fuel into an internal combustion engine, it is more likely that a small amount of fuel would be diverted from the main supply to be pushed through the permeable wall utilizing the same fluid motive force as that which drives the bulk flow. Based on the ratio of mass flow through the wall desired, the permeable wall porosity or channel size must be varied accordingly.

In some embodiments, as it relates to high temperature, turbine design permeable wall structures comprising the exterior of each turbine blade are used to coat each blade in a desired fluid. This accomplishes enhanced cooling and reduced temperatures seen by each blade, along with reduced aerodynamic drag between the blade and working fluid. If the fluid used through the permeable wall of the blade is a fuel, some energy may be recovered from the cooling cycle through its combustion.

Unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. An engine comprising:
a non-permeable outer wall casing;
a permeable inner wall;
an intra-wall propellant channel between the non-permeable outer wall and the permeable inner wall; and
a combustion chamber formed at least in part by the permeable inner wall;
wherein:
the intra-wall propellant channel is configured to permit a non-solid propellant to flow between the non-permeable outer wall and the permeable inner wall; and
the permeable inner wall is configured to permit the non-solid propellant to porously flow through the permeable inner wall, from the intra-wall propellant channel to the combustion chamber.

2. The engine of claim 1, further comprising an injector positioned at a forward portion of the combustion chamber.

3. The engine of claim 2, wherein the injector is configured to inject an oxidizer element into the combustion chamber.

4. The engine of claim 3, wherein thrust is generated when the oxidizer element ignites with the non-solid propellant that flows into the combustion chamber through the permeable inner wall.

5. The engine of claim 4, wherein mass flow of the oxidizer element is modulated to generate a desired thrust profile.

6. The engine of claim 1, wherein the non-solid propellant is drawn into the combustion chamber through the permeable inner wall by a pressure differential between the combustion chamber and the intra-wall propellant channel.

7. The engine of claim 6, wherein the pressure differential is formed at least in part by the vacuum of space.

8. The engine of claim 1, further comprising a solid fuel grain positioned within the combustion chamber.

9. The engine of claim 8, wherein the non-solid propellant is configured to protectively coat the combustion chamber through the permeable inner wall as the solid fuel grain is burned to create thrust.

10. The engine of claim 1, wherein the permeable inner wall comprises a plurality of porous passages configured to permit non-solid flow from one side of the permeable inner wall to an opposite side.

11. The engine of claim 10, wherein the plurality of porous passages vary in size.

12. The engine of claim 11, wherein the sizes of the porous passages are determined based on a desired thrust profile calibrated to varying amounts of non-solid propellant that are permitted to flow through the permeable inner wall due to the varying sizes of the porous passages.

13. The engine of claim 1, wherein the inner permeable wall is shaped to a specified geometry such that combustion of fuel in the combustion chamber generates a desired thrust profile.

14. The engine of claim 1, wherein the inner permeable wall includes porous passages of specified sizes such that combustion of fuel in the combustion chamber generates a desired thrust profile.

15. The engine of claim 1, further comprising a refueling chamber coupled to the intra-wall propellant channel and configured to permit refueling of the non-solid propellant.

16. The engine of claim 1, wherein the non-permeable wall structure and the permeable inner wall structure are generated using additive manufacturing techniques.

17. The engine of claim 1, further comprising a nozzle coupled to an aft portion of the combustion chamber.

18. The engine of claim 1, further comprising one or more pistons driven by combustion of fuel in the combustion chamber.

19. The engine of claim 1, further comprising one or more turbine propellers.
